(19) United States
(12) Patent Application Publication
(10) Pub. No.: US 2012/0275141 A1
(43) Pub. Date: Nov. 1, 2012

(54) PORTABLE LIGHT WITH CENTER PULL SUCTION CUP AND METHOD OF USE

(76) Inventor: Brent Hamilton Keith, Jefferson, NC (US)

(21) Appl. No.: 13/094,626

(22) Filed: Apr. 26, 2011

(51) Int. Cl. F21L 4/00; B23P 11/00

(52) U.S. Cl. 362/158; 29/428

(57) ABSTRACT

A portable light assembly for projecting light through a substrate, the assembly including a housing, a center pull vacuum sealable mechanism integrated into the housing, the vacuum sealable mechanism configured to removably engage the substrate, and a plurality of light sources positioned within the housing and adjacent a perimeter of the vacuum sealable mechanism, and functions to project light through the substrate or away from substrate.

### TECHNICAL FIELD

The disclosure relates generally to an illumination device and more specifically it relates to an illumination device having a suction cup to adhere to a transparent surface for projecting a light beam there through.

### BACKGROUND

It is well known that lights, safety flashers and other illumination devices are effective at lighting a road to be traveled or warning travelers at night and so have been adapted to vehicles, aircraft, emergency vehicles and the like. Emergency service personnel such as, fire, medical, and police (urban police officers, highway patrols, and military police) use emergency lighting to illuminate their work space and to protect travelers into emergency space. Emergency lighting is primarily designed to focus lighting over a large area. An example of this type of light is a flood light that is positioned relatively close to the area of intended illumination. This type of lighting is typically vehicle based or hand held and is utilized to disperse the light over a wide area or area to be traversed. If the lighting situation requires illumination inside a confined space, such as a vehicle, that is sheltered from ambient light, focusing the light beam becomes more difficult. The flood light may illuminate the outer surface of the confined space or vehicle but does little to illuminate the interior of the confined space. A specific example of a confined space is the interior of a vehicle pulled over during a police stop.

Attempts to resolve the problem of illuminating the interior of confined spaces or vehicle have involved the use of hand held lighting devices such as flashlights. Unfortunately, hand held lighting devices require the user to hold and point the light toward the area of intended illumination. This restricts the user's ability to use both hands to render aid or engage in policing activities. Further, hand held lighting devices are not intended to be positioned in the confined space or vehicle and user must lay them down on a surface or wedge them by some means in order to use both hands. Moreover, it is common for the officer to leave the headlights or a spotlight on in the police car and direct the police car lights at the stopped vehicle or person. However, the headlights and spotlight cannot illuminate through the rear window and seat backs of a vehicle effectively preventing a clear view of the interior of the vehicle. Plus leaving the patrol car lights on, especially a spotlight, poses a serious threat to drivers in oncoming traffic as they can be blinded or distracted by the lights. Additionally, an officer walking in the headlights/spotlight toward a stopped vehicle makes an easy target if the occupant(s) of the stopped vehicle is planning an attack on the officer since the back lighting creates a silhouette of the officer.

With increasing violence against urban police officers, highway patrols, military police and any one who is out at night, such personnel need safety products that combine current products while enabling their hands to remain free. It is dangerous for a police officer to approach a vehicle with tinted windows and un-tinted windows at night without being able to see inside the interior of the confined space or who/what is inside the interior of the confined space or vehicle.

Therefore, it is readily apparent that there is a recognizable unmet need for a portable light assembly with center pull suction cup and method of use, for hands-free lighting, wherein a portable light may be configured with a center pull suction cup to adhere to a transparent window with added features for illuminating the interior of confined spaces or vehicle providing the officer with a safer apparatus and method of investigating a stopped vehicle.

### BRIEF SUMMARY

Briefly described, in example embodiments, the present apparatus overcomes the above-mentioned disadvantage, and meets the recognized need for a portable light assembly with center pull suction cup and method of use, for hands-free illumination of the interior of confined spaces or vehicle comprising, in general, a portable light assembly for projecting light through a substrate, the assembly comprising a housing, a center pull vacuum sealable mechanism, the vacuum sealable mechanism configured to removably engage the substrate, and a plurality of light sources positioned adjacent a perimeter of the vacuum sealable mechanism and/or a top plate, and thus, functions to project light through the substrate or away from the substrate.

According to its major aspects and broadly stated, the apparatus is, in general, a portable light assembly for projecting light through a substrate, the assembly comprising a housing, a center pull vacuum sealable mechanism integrated into the housing, the vacuum sealable mechanism configured to removably engage the substrate, and a plurality of light sources positioned within the housing and adjacent a perimeter of the vacuum sealable mechanism to project light through the substrate.

In a further exemplary embodiment, a portable light assembly for projecting light through a substrate, the assembly comprising a housing, a center pull vacuum sealable mechanism integrated into the housing, the vacuum sealable mechanism configured to removably engage the substrate, a plurality of light sources positioned within the housing and adjacent a perimeter of the vacuum sealable mechanism, and wherein said housing further comprises a second plurality of light sources configured to project light away from the substrate.

In still a further exemplary embodiment of the method of illuminating the interior of confined spaces or vehicle by affixing a portable light assembly to a substrate, including the steps of providing a portable light assembly, which further comprises a housing, a center pull vacuum sealable mechanism integrated into the housing, the vacuum sealable mechanism configured to removably engage the substrate, and a plurality of light sources positioned within the housing and adjacent a perimeter of the vacuum sealable mechanism, the light sources configured to project light through the substrate; positioning the portable light assembly on the substrate; securing the portable light assembly to the substrate; and illuminating a space beyond the substrate.

Accordingly, a feature of the portable light assembly is its ability to provide a center pull suction cup to removably affix the portable light assembly to a substrate for hands-free illumination of the interior of confined spaces or vehicle, or provide reverse lighting when portable light assembly is removably affixed to any structure.

Another feature of the portable light assembly is its ability to provide illumination of the interior of confined spaces or vehicle, home or commercial building.

Still another feature of the portable light assembly is its ability to provide a handle for hand held operation and positioning of the portable light assembly.

Yet another feature of the portable light assembly is its ability to provide a light assembly with a suction release apparatus to disengage the shielded or hidden center pull suction cup from the transparent or smooth substrate.

Yet another feature of the portable light assembly is its ability to provide a light assembly with a center pull suction cup having a lever and pull apparatus.

Yet another feature of the portable light assembly is its ability to provide a light assembly with lights positioned on the perimeter of the center pull suction cup.

Yet another feature of the portable light assembly is its ability to provide a light assembly protected from the elements by an enclosed moisture proof housing.

Yet another feature of the portable light assembly is its ability to provide a light assembly with red, yellow and/or white and/or strobe lights to be utilized as a warning beacon or flare.

Yet another feature of the portable light assembly is its ability to provide a light assembly with an audio recording apparatus.

Yet another feature of the portable light assembly is its ability to provide a light assembly with a peripheral light blocking skirt.

Yet another feature of the portable light assembly is its ability to provide a light assembly with lights positioned facing away from the suction cup for hands-free illumination of a space adjacent a suctioned substrate.

Yet another feature of the portable light assembly is its ability to provide a light assembly with a video recording apparatus.

Yet another feature of the portable light assembly is its ability to provide a light assembly with a camera or picture recording apparatus.

Yet another feature of the portable light assembly is its ability to provide a light assembly with a gas canister, tubing, trigger, and nozzle for delivery of a pressurized gas such as MACE.

Yet another feature of the portable light assembly is its ability to provide a light assembly with a charging station and docking station.

Yet another feature of the portable light assembly is its ability to provide a light assembly for service personnel such as, fire, medical, and police use for emergency lighting to illuminate their work space, record suspect activity, assist with the protection of service personnel, and to protect travelers into emergency space.

Yet another feature of the portable light assembly is its ability to provide illumination in a confined space or interior of a stopped vehicle, especially a vehicle with tinted windows or dark interiors where it is difficult for the officer to see what or who is inside the confined space or stopped vehicle and what the occupant(s) are doing.

Yet another feature of the portable light assembly is its ability to allow the officer to move independent of the light's source such as would be the case with a flashlight.

Yet another feature of the portable light assembly is its ability to provide a threaded camera mount for mounting the portable light assembly onto a tripod to position the portable light and illuminate an accident scene with the white lights or as a flare by switching to the red lights.

Yet another feature of the portable light assembly is its ability to provide emergency responders, responding at an accident site, with a light that can be stuck on a vehicle window, placed on a tripod, or affixed to any smooth surface such as a rescue vehicle's side to help in illuminating their work area and rescue efforts. For example, when an accident site includes a vehicle with a person trapped inside and the light can be stuck onto a window, hood, trunk, or placed on a tripod to help in their rescue.

Yet another feature of the portable light assembly is its ability to provide an officer responding to a crime scene involving a person inside a building, whereby law enforcement can suction the light to the building window to see inside, while officers work the crime scene.

Yet another feature of the portable light assembly is its ability to provide an officer with the ability to adhere the portable light assembly onto the vehicle's driver side window at such a position to prevent the driver from rolling down the window beyond a fixed distance, preventing the driver from leveling a gun at the officer or slash the officer with a knife, or hit the officer with a wrench or other weapon.

Yet another feature of the portable light assembly is its ability to simply leave the light off and affix the portable light assembly onto the body of the vehicle while the officer is examining driver's licenses or writing a ticket. To keep the officer from forgetting to take the light, a small “always on’ colored LED indicator lamp can remind the officer to remove the light when the event is finished.

Yet another feature of the portable light assembly is its ability to provide lid mounted light devices to aid the officer in hands free examining of a driver's license or the writing of a ticket.

Yet another feature of the portable light assembly is its ability to be used by an officer as a protective baton or shield if the need arose.

These and other features of the portable light assembly will become more apparent to one skilled in the art from the following Detailed Description of the Embodiments and Claims when read in light of the accompanying drawing Figures.

### BRIEF DESCRIPTION OF THE DRAWINGS

The present portable light assembly and method of use, for hands-free illumination of the interior of confined spaces, vehicle interior, accident or crime scene, or work area will be better understood by reading the Detailed Description of the embodiments with reference to the accompanying drawing figures, in which like reference numerals denote similar structure and refer to like elements throughout, and in which:

FIG. 1 is a partial cross-section side view of an example embodiment of the portable light assembly positioned in a docking and/or charging station;

FIG. 2 is a partial cross-sectional side view of an example embodiment of the portable light assembly showing the assembly engaging a cross section of a windshield;

FIG. 3 is a perspective view of an example embodiment of the portable light assembly shown in an exploded component view;

FIG. 4 is an electrical diagram of an example embodiment of the portable light assembly showing power source, voltage regulator and dimmer components;

FIG. 5 a mechanical diagram of an example embodiment of the portable light assembly showing canister, tubing, trigger and nozzle components;

FIG. 6 is an electrical block diagram of an example embodiment of the portable light assembly showing power source, microphone, and audio/video recording apparatus;

FIG. 7 is a partial cross-sectional side view of an example embodiment of the portable light assembly showing lid mounted LEDs; and

FIG. 8 is a flow diagram of a method of illuminating the interior of confined spaces, vehicle, interior or site.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

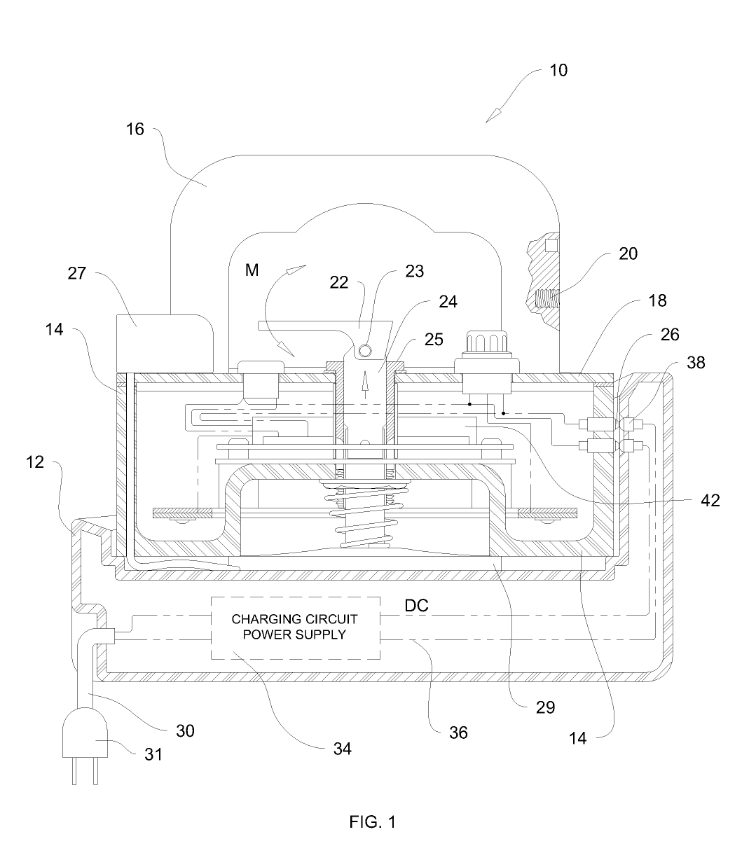

In describing the exemplary embodiments of the present disclosure, as illustrated in FIGS. 1-8 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1, by way of example, and not limitation, there is illustrated an example embodiment of portable light assembly 10 positioned in a charging or recharging station such as docking station 12. Preferably, portable light assembly 10 comprises an exterior skeleton or canister such as housing 14, configured to house or contain the components and/or subcomponents of portable light assembly 10. Housing 14 preferably includes a removable lid such as top 18 configured to releasably seal and close housing 14. Furthermore, top 18 preferably includes handle 16, which may be configured to be stationary, hinged or pivoting about top 18. Together housing 14 and top 18 are preferably configured as an impact resistant, waterproof, and/or sealed container for the protection of internal component parts of portable light assembly 10. Handle 16, housing 14 and/or top 18 preferably includes an aperture formed therein such as threaded mount 20 configured to affix portable light assembly 10 to threaded attachment, such as a tripod or stand, to either light up an accident scene with the white lights or as a warning flare when the red lights are switched on.

It is contemplated herein that housing 14 of portable light assembly 10 may be formed of a frame with exterior cover, formed from one or more pieces, or a single molded piece and may have a variety of sizes and shapes such as, but not limited to, circular, cylindrical, semi-circular, square, triangular, or other polyhedral or even irregular custom shapes.

When not in use, portable light assembly 10 is preferably positioned in docking station 12 configured to receive input power from an external power source and convert such power to the charging power (required by batteries 42), such as external power source 30 for re-charging portable light assembly 10.

Housing 14, top 18, handle 16, and docking station 12, are preferably formed of a suitable material, such as plastic, polyvinyl chloride (PVC), aluminum, steel, iron, rigid plastic or plastic with metal inserts for strength, fiber, composite, metal, alloy, stainless steel, or the like, capable of providing structure to portable light assembly 10. Moreover, such material may be painted, powder coated, finished with different coatings known in the industry, or installed with no finish relying upon the natural color of the material utilized. Preferably, the material includes other suitable characteristics, such as transparency, durability, rust-resistance, light weight, heat-resistance, chemical inertness, oxidation resistance, ease of workability, or other beneficial characteristic understood by one skilled in the art.

It is contemplated herein that housing 14 and top 18 may be configured and/or sized to accommodate various sizes of illumination systems, adhesion systems, and other components or subsystems required of service personnel such as, fire, medical, and police use for emergency lighting to illuminate their work space, record suspect activity, assist with the protection of service personnel, and to protect travelers into emergency space.

Referring again to FIG. 1, there is illustrated docking station 12, which preferably further includes a schematic diagram of the external power source such as external power source 30, which includes plug 31 configured to adjust the power of power source 30 to meet the power requirements of portable light assembly 10 and may include transformer, power converter, voltage regulator, charge controller, shut down circuit and the like, such as charging circuit power supply 34 configured to convert power source 30 into a charging power such as direct current (DC) for charging the rechargeable power source, batteries 42, of portable light assembly 10. Preferably, wires 36 carry the electric power from one electrical component to the next terminating at energy output contacts 38, which are positioned to be in contact with energy input contacts 26, when portable light assembly 10 is placed in docking station 12 for recharge. It is contemplated herein that power source 30 may be alternating current (AC) utilizing plug 31 or alternatively may be direct current (DC) requiring a DC adapter such as a cigarette lighter when positioned in a vehicle such as a police car. Power source 30 preferably includes a shut down circuit integrated in rectifier 34 and configured to block power source 30 when charging of portable light assembly 10 is complete or to meet the charging requirements of batteries 42. It is contemplated herein that portable light assembly 10 may utilize any suitable source of power such as electrical energy.

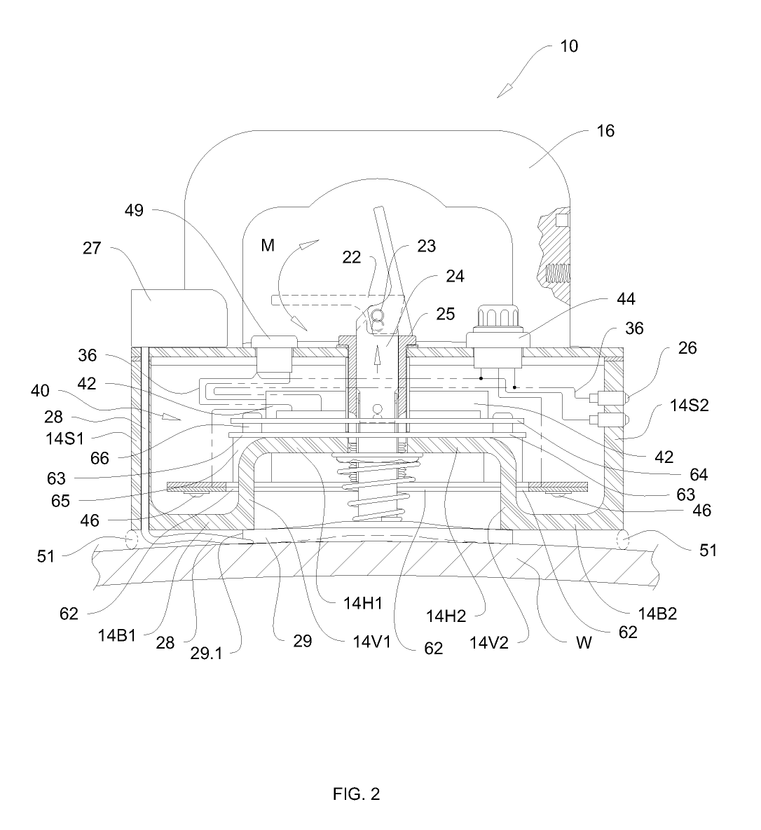

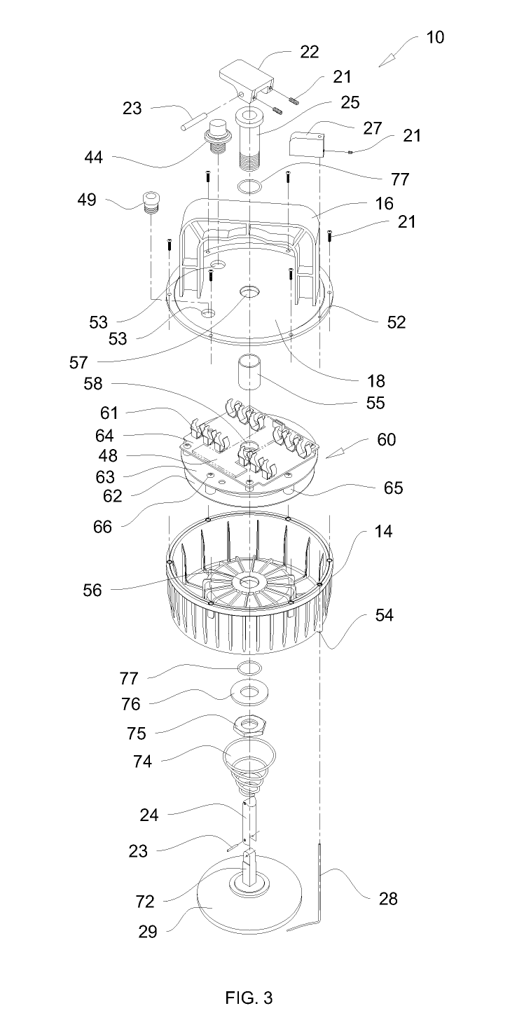

Referring now to FIGS. 2 and 3, there is illustrated a side view of an example embodiment of portable light assembly 10 shown affixed to substrate W. Preferably, housing 14 further includes perimeter sidewalls 14S1 and 14S2, annular ring such as bottom walls 14B1 and 14B2, internal vertical walls 14V1 and 14V2, and internal horizontal walls 14H1 and 14H2, all configured to encase portable light assembly 10 internal components and maintain a waterproof sealed container for such parts therein and enable mechanical movement of parts therein. Bottom walls 14B1 and 14B2 are preferably formed of a suitable transparent material, such as acrylic configured to be a lens or optical window allowing light to shine there through.

Furthermore, portable light assembly 10 preferably includes a lever such as finger latch 22, which is preferably connected to a first end of an extension linkage such as pull bar 24 whereby finger latch 22 and a first end of pull bar 24 are pivotally connected by a pivot mechanism such as pin 23. Preferably, pull bar 24 travels within a conduit such as sleeve 25 configured to connect finger latch 22 to a vacuum sealable mechanism such as center pull suction cup 29 configured to affix portable light assembly 10 to a surface such as glass, which may be a windshield, window, glass, substrate, structure, or any surface (transparent or non-transparent), such as substrate W. Substrate W may include any smooth surface transparent or not transparent, glass, window, vehicle window such as an automobile, or any building window located anywhere in a building and the like. It is contemplated herein that suction cup 29 is preferably formed of a suitable material, such as silicone, soft rubber, plastic, or the like capable of providing a vacuum seal to affix portable light assembly 10 to substrate W and may be configured in any suitable planar form such as a circle, square and the like. Preferably, the material includes other suitable characteristics, such as flexible, pliable, formability, in which readily forms to any surface or substrate W, transparency, durability, rust-resistance, light weight, chemical inertness, oxidation resistance, ease of workability, or other beneficial characteristic understood by one skilled in the art.

It is well known that suction cups do not easily release, particularly from glass, even when the vacuum is released, therefore a reliable release mechanism, such as release handle 27 and bent rod 28 is necessary due to the hidden nature of suction cup 29 within housing 14, and thus is preferably configured to disengage portable light assembly 10 from substrate W.

Still further, portable light assembly 10 preferably includes a vacuum release mechanism such as release handle 27, which rotationally connects to bent rod 28. Preferably, bent rod 28 is positioned through an aperture such as rod hole 52 in top 18 and continues through a conduit or passage way such as hole 54 in perimeter sidewalls 14S1 of housing 14 (shown in FIG. 3) to contact inaccessible or hidden contacts edge 29.1 of suction cup 29. In operation, an operator releases finger latch 22 to release the vacuum from suction cup 29; however, if portable light assembly 10 continues to adhere to substrate W, the operator may rotate release handle 27, which rotates bent rod 28, which further contacts edge 29.1 of suction cup 29 to release the vacuum between suction cup 29 and substrate W. It is recognized that portable light assembly 10 may include other vacuum release mechanisms such as a tab connected to suction cup 29 or the like understood by one skilled in the art.

Referring again to FIG. 2, there is illustrated a light source such as lighting system 40 that preferably includes an energy source such as batteries 42, energy input contacts 26, an ON/OFF/DIMMER/INDICATOR switch such as electrical switch 44, one or more light sources such as light emitting diodes 46 (LEDs), and connection wires 36. Furthermore, FIG. 2 further illustrates an internal support housing such as platform 60 (shown in FIG. 3) that preferably includes a first planar platform such as light source platform 62 configured to position an array of light emitting diodes 46 preferably in an annular ring, circular arc or other configuration adjacent the perimeter of exterior edge 29.1 of suction cup 29. Light emitting diodes 46 preferably emit light through transparent bottom walls 14B1 and 14B2 and subsequently through substrate W to illuminate the space beyond substrate W. It is contemplated herein that light emitting diodes 46 may include any variety of light source whether, incandescent, florescent, or any other light sources understood by one skilled in the art, including colored light or colored light emitting diodes 46 such as red or yellow and the like, and that such light emitting diodes 46 may further flash on and off to act as a warning light.

Light emitting diodes 46 are manufactured by several manufactures and may be interchangeably utilized in portable light assembly 10. An example light emitting diodes 46 is the category of Phillips' LUMILEDS REBELS or the Cree′ XR-E high brightness LEDs, which draws approximately 700 milliamps (mA) at a forward voltage (Vf) of 3.6 volts per light emitting diode 46, which yields more than 100 lumens per lamp capable of providing lumens to portable light assembly 10. In an exemplary embodiment, portable light assembly 10 preferably includes one or more light emitting diodes 46, more specifically eight (8) light emitting diodes 46, and provides approximately eight hundred (800) lumens of directional light and requires 8×700 mA approximately 5,600 mAh of power from batteries 42. When eight hundred (800) lumens of directional light are projected into the interior of a vehicle such light is capable of illuminating the interior space of the vehicle.

It is contemplated herein that a variety and number of light sources, known and unknown, whether incandescent, florescent, LED, or the like, may be utilized provided such light source is capable of producing a large number of lumens of directional light with low power requirements.

It is further contemplated herein that light emitting diodes 46 may be configured with infra red or other non visible LEDs to “illuminate” the vehicle's interior through substrate W. The operator, such as an officer, would be required to utilize special goggles to match the wavelength of the LED illumination to view activity or contents occurring within substrate W. Still further, portable light assembly 10 may be equipped with variable wavelength light emitting diodes 46 that could be tuned to match a tint applied to substrate W and increase visibility therethrough.

It is recognized that very bright white light emitting diodes 46 can shine through highly tinted windows, and when the light beam reflects off of substrate W are blocked by skirt 51, an operator can see inside the vehicle with the darkest legal tint.

It is still further contemplated herein that light emitting diodes 46 may be turned ON/OFF automatically by integration of electrical switch 44 and finger latch 22 wherein finger latch 22 is configured to turn ON light emitting diodes 46 when in a first position (vacuum position) and is configured to turn OFF light emitting diodes 46 when in a second position (vacuum released).

It is further contemplated herein that perimeter sidewalls 14S1 and 14S2 and/or bottom walls 14B1 and 14B2 may include a peripheral shield or perimeter bumper formed of soft rubber or silicone such as skirt 51 positioned in an annular ring or circular arc approximate light emitting diodes 46 and opposite exterior edge 29.1 of suction cup 29. Skirt 51 is preferably utilized to prevent light from escaping from underneath portable light assembly 10, especially when affixed to a curved substrate W, which interferes with the view inside substrate W.

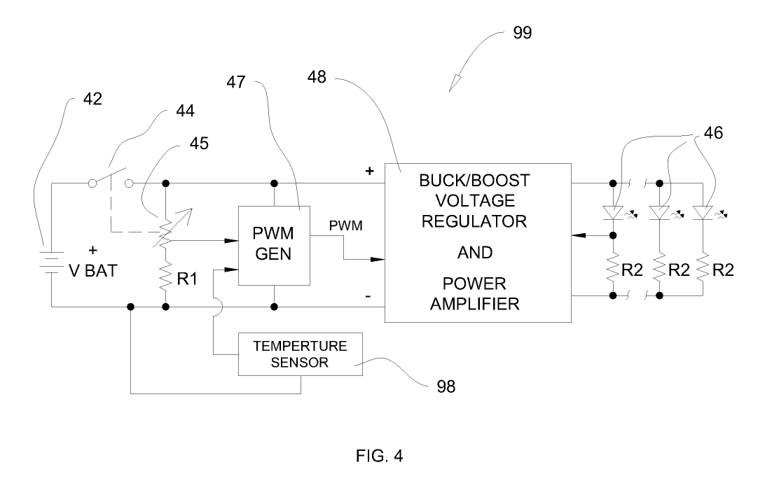

Although a battery pack of any reasonable voltage preferably with a buck/boost regulator, may be used, to power portable light assembly 10 the energy source of one or more batteries, battery pack or bank, such as batteries 42, preferably includes one or more banks or sets of rechargeable double AA NiMh, Li-Ion, or NiCd batteries or other energy storage sources understood by one skilled in the art may be positioned in pronged clips such as battery clips 61 (shown in FIG. 3). Preferably, batteries 42 include banks or sets of three double AA batteries. Each set of three batteries 42 may be wired in series for a simple energy source, yielding the required 3.6 volts that is required to power light emitting diodes 46 at full brightness. More specifically portable light assembly 10 may include LED driver module 99, (shown in FIG. 4) added to lighting system 40, and may be configured to produce any reasonable voltage from a few volts to twelve (12) or more at desired current. Depending on the battery manufacturer selected and the number of batteries wired in series or parallel, the battery pack combination may yield approximately 4,000 to 5,600 mAh, which is enough to operate light emitting diodes 46 for the specified approximate twenty (20) minutes. Preferably, portable light assembly 10 includes rechargeable batteries, which may be recharged in docking station 12 located inside the patrol vehicle or the like to maintain portable light assembly 10 at full charge.

It is recognized that, a variety and number of energy sources, known and unknown, whether AA, AAA, 9V cells, or the like, wired in series or parallel, may be utilized for battery 42 provided LED driver module 99 is selected to match the battery configuration and power requirements of light emitting diodes 46.

It is contemplated herein that larger numbers of light emitting diodes 46 are possible to accommodate illumination of larger interior spaces and/or areas.

Referring now to FIGS. 3 and 4, light emitting diodes 46 are configured in surface mount technology for direct placement on a metal clad printed circuit board preferably configured as an annular plate, shown as light source platform 62 which preferably is formed of heat transferable material such as aluminum and is configured as part of the heat sinking system of lighting system 40. Alternatively, light emitting diodes 46 may be in a “star” configuration and wired together in either series or parallel and mounted on light source platform 62, which in this case may be an aluminum annular plate. Whether mounted directly to metal clad printed circuit boards or in the “star” configuration, a further heat transferable material, such as heat sink 63 may be preferably required to absorb and dissipate the heat generated by light emitting diodes 46. Preferably, the specification for user, such as an officer, requires operation at full brightness for approximately twenty (20) minutes without overheating; the present configuration as shown in FIG. 2, utilizes an aluminum heat sink such as heat sink 63 to draw heat away from light emitting diodes 46. The heat generated by light emitting diodes 46 may be further transferred to heat sink 63 by a spacer such as aluminum spacer 65 which may use thermal heat sink compound to further accomplish the heat transfer.

Preferably, lighting system 40 may be dimmed by a rotary variable resistor like those found in audio circuits or wall lamp dimmers such as electrical switch 44 and dimmer control 45 shown in FIG. 4. Alternatively, voltage regulator and power amplifier 48 (as shown in FIG. 4) preferably controls the average voltage by pulse width modulation (PWM) applied to light emitting diodes 46.

To assure that light emitting diodes 46 do not overheat voltage regulator and power amplifier 48 is preferably connected to a temperature sensor 98 (shown in FIG. 4) that senses the temperature of light source platform 62 and, thus, reduces the power to light emitting diodes 46 when their temperature reaches a preset, “never to exceed” temperature.

Moreover, electrical switch 44 may preferably be mounted at any convenient location, more specifically, as shown in FIG. 2 electrical switch 44 may preferably be positioned on top 18 in close proximity to handle 16 for easy access by the operator's finger. In dimmable configurations, electrical switch 44 and dimmer control 45 may be configured as part of the dimming mechanism that includes a rotary potentiometer integrated with ON-OFF switch. Preferably, electrical switch and dimmer 44 may be configured to be a waterproof assembly. In another exemplary embodiment, indicator light 49 may be utilized so that the operator knows the whereabouts of portable light assembly 10. Moreover, indicator light 49 may also be utilized as a visual guide to make sure portable light assembly 10 is indexed correctly so as to fit into docking station 12.

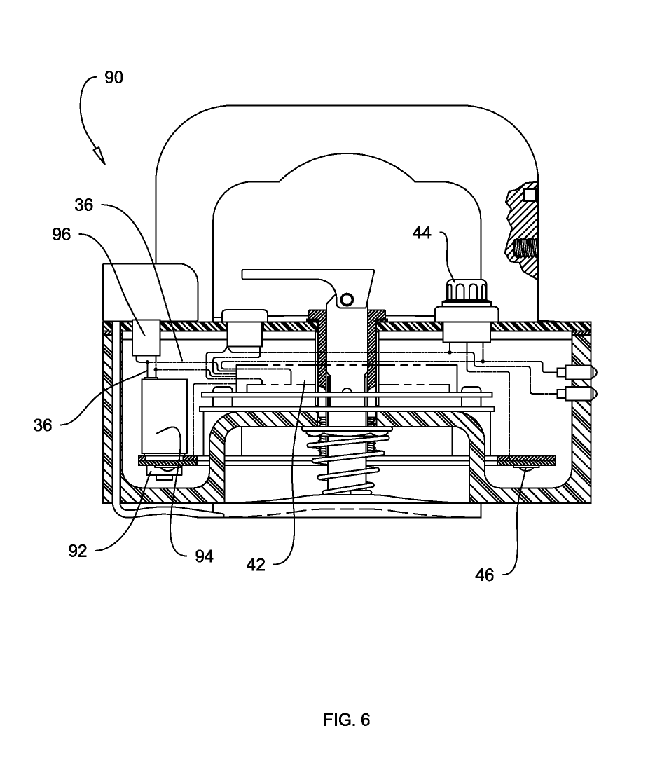

In use, portable light assembly 10 may be configured to utilize electrical switch 44 to vary or select the brightness of light emitting diodes 46. An operator, such as an officer, may adjust electrical switch 44 dimming light emitting diodes 46 so as to start with a non intimidating light if the driver/passenger(s) appeared to be no threat to the officer. However, if a threat or concern appeared the officer may re-configure dimmer control 45 to select brighter or full brightness light emitting diodes 46, or flash/strobe, thus, to cause the whole light emitting diodes 46 array to go to full brightness and/or on off to confuse or warn the suspect. Moreover, electrical switch 44 may be controlled ON/OFF/DIM remotely with a transmitter/receiver similar to the keyless lock transmitter used in automobiles or with a communication port such as USB port 96 similar to the wireless mouse, as shown in FIG. 6).

Referring again to FIGS. 2 and 3, preferably lighting system 40 may further include an indicator light 49 configured to indicate when electrical power from batteries 42 is supplying flashing/warning light emitting diodes 46 and/or alternatively provide an indicator light such as indicator light 49 positioned in top 18 to indicate to an operator the whereabouts of portable light assembly 10. Moreover, indicator light 49 may be utilized as a visual guide to indicate whether portable light assembly 10 is properly positioned within docking station 12 and/or the status of charge of batteries 42, as in whether charging/fully charged/needs maintenance.

Input contacts 26 are preferably configured to transfer power from docking station 12 to portable light assembly 10. Input contacts 26 may be positioned on the periphery of housing 14 as shown in FIG. 1. Input contacts 26 are preferably configured to fit matching output contacts 38 of docking station 12. It is contemplated herein that input contacts 26 may be positioned on housing 14, more specifically one input contact 26 each may be positioned on each side of sidewall 14S1 and sidewall 14S2 and configured to mate with like contacts positioned in docking station 12.

Referring now to FIG. 3, there is illustrated a perspective view of an example embodiment of portable light assembly 10 shown in an exploded component view. Preferably, suction cup 29 further includes a center pull such as post 72, which is preferably connected to a second end of pull bar 24 whereby post 72 and second end of pull bar 24 are pivotally connected by a pivot mechanism such as pin 23, and the other end, first end of pull bar 24 is connected to finger latch 22, whereby first end of pull bar 24 and finger latch 22 are additionally pivotally connected by a pivot mechanism such as pin 23. Next, an upward motion M of finger latch 22 preferably causes the center portion of suction cup 29 to rise resulting in a vacuum created under suction cup 29 and adhesion of suction cup 29 and portable light assembly 10 to substrate W. Upon a release of finger latch 22 bias member such as coil spring 74, in a compressed state expands in a downward motion M of finger latch 22, which causes the center portion of suction cup 29 to fall resulting in a release of vacuum and adhesion of suction cup 29, whereby portable light assembly 10 may disengage substrate W. A conduit or passage way through portable light assembly 10 is formed by a series of apertures including aperture such as housing hole 56, aperture such as platform hole 58, conduit such as spacer 55, and aperture such as top hole 57 to configure a conduit for internal movement of pull bar 24 and post 72. Moreover, machined or molded sleeve 25 is preferably configured to be inserted through such conduit or passage way of top hole 57, spacer 55, platform hole 58, housing hole 56, washer 76, lock washer 77, and affixing mechanism such as nut 75 to configure a conduit for internal movement of pull bar 24 and post 72.

In use, portable light assembly 10 is preferably positioned on substrate W where an operator pulls finger latch 22 to the full up position. This causes the pull bar 24 and post 72 to pull the center of suction cup 29 up and the housing 14 down, thereby further sealing the edge of the suction cup and skirt 51 against substrate W. The rising center of the suction cup increases the vacuum in the cavity between substrate W until the over-center position is reached with finger latch 22, wherein suction cup 29 securely affixes or latches portable light assembly 10 to substrate W.

Preferably housing 14 and top 18 enclose platform 60 which further includes one or more planar platform or printed circuit board such as battery platform 64 configured to connect batteries 42, voltage regulator and power amplifier 48, and which may be fabricated as a component part of battery platform 64. Battery platform 64 is preferably positioned in parallel with and approximate heat sink 63 and held in position by an attachment mechanism such as small metal spacer 65 and screw 66. Moreover, heat sink 63 is preferably positioned in parallel with and approximate light source platform 62 and held in position by an attachment mechanism such as small metal spacer 65 and screw 66.

It is recognized that battery platform 64 and light source platform 62 are preferably positioned within sealed housing 14, configured to house and/or contain the components and subcomponents of portable light assembly 10.

It is further recognized that spacer 55 functions to secure platform 60 to housing 14 and to vertically position platform 60 within the space formed by top 18 and housing 14 and further configured to position platform 60 without screws or fasteners.

It is still further recognized that spacer 55 is configured to function as a structural support or member to strengthen housing 14.

Preferably top 18 includes one or more apertures such as top hole 57 wherein sleeve 25 is preferably configured to be inserted there through and offset top hole 53 where electrical switch/electrical switch 44 or electrical switch/indicator light 49 is preferably configured to be inserted through.

Referring now to FIG. 4 there is illustrated an electrical block diagram of an example embodiment of LED driver module 99. Preferably, LED driver module 99 includes batteries 42, switch 44, potentiometer such as dimmer control 45, resistor R1, PWM GEN 47, buck/boost voltage regulator and power amplifier 48, light emitting diodes 46, and resistor R2. Moreover, buck/boost voltage regulator and power amplifier 48 may include the Maxim 1759 buck/boost regulator which can accommodate battery voltages from approximately 1.6 to 5.5 volts and create an adjustable steady output voltage in the range of approximately 2.5 volts to 5.5 volts at a maximum of 100 milliamperes. It is recognized herein that to achieve sufficient current to drive the bank of light emitting diodes 46, a power amplifier is preferably provided to raise output current of buck/boost voltage regulator and power amplifier 48 to approximately 5600 milliamperes to accommodate approximately eight (8) light emitting diodes 46 operating in parallel at 700 milliamperes each from approximately 3.0 to 4.5 volts bank of batteries 42 connected to VBAT. It is contemplated herein that other voltage and power amplifier circuit configurations may be utilized using other similar components provided by the integrated circuit industry such as MOSFET transistors, capacitors and resistors and known by those of ordinarily skilled in the art.

Referring again to FIG. 4, LED driver module 99 preferably includes batteries 42 and electrical switch 44 positioned in parallel with dimmer control 45 and resistor R1, which is positioned in parallel with a pulse width modulation (PWM) device such as PMW GEN 47, which is positioned in parallel with buck/boost voltage regulator and power amplifier 48, which is further positioned in parallel with one or more light emitting diodes 46 and resistor R2. In operation, LED driver module 99 receives an input from dimmer control 45 which causes buck/boost voltage regulator and power amplifier 48 to pulse the output thereby varying the power to parallel light emitting diodes 46 and resistor R2, and thus varies the light intensity of light emitting diodes 46.

Electrical switch 44 may be mounted at any convenient location such as on top 18 for easy operator access. For example, as shown in FIG. 2, electrical switch 44 is preferably located on top 18 near handle 16 for easy access by the operator's finger. In an exemplary embodiment, electrical switch 44 may be lit with a small (preferably red) indicator light 49 so that the user knows the whereabouts of the suction cup latch 22 and/or portable light assembly 10.

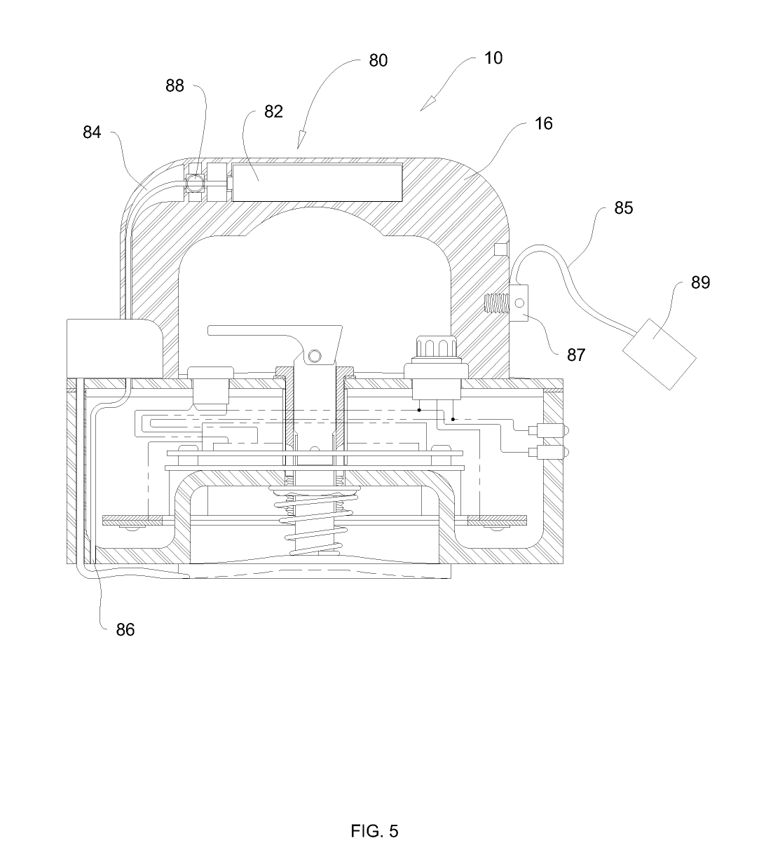

Referring now to FIG. 5, there is illustrated a cut away showing pressurized chemical repellent or irritant system such as chemical dispensing system 80 that preferably includes a canister such as chemical repellent canister 82, a conduit such as tube 84, an on/off mechanism such as valve 88, and nozzle 86. Canister 82 is positioned in portable light assembly 10, preferably in handle 16. Tube 84 preferably connects canister 82 to nozzle 86, which nozzle 86 is preferably positioned approximate housing bottom walls 14B1 and/or 14B2. Valve 88 is positioned along tube 84 preferably positioned in handle 16 where it is easily operated by an operator gripping handle 16. When valve 88 is triggered or placed in the open position it releases the pressurized repellent or irritant held under pressure in canister 82. The released repellent or irritant travels through tube 80 to nozzle 86 where its pressurized contents is projected from housing bottom walls 14B1 and/or 14B2 of portable light assembly 10. The chemical repellent or irritant may include MACE, pepper spray, tear gas, or any other chemical repellent or irritant capable of being held under pressure by closed valve 88 and canister 82.

In use, an operator may utilize portable light assembly 10 as a formidable protection device. An operator may position portable light assembly 10 and adjust the brightness to a high level momentarily while at the same time aiming portable light assembly 10 at an attacker, blinding him or her with the bright light. In addition an alternate form of defense is to utilize chemical dispensing system 80 to propel a chemical repellent or irritant at the attacker. Still further the two defensive measures could occur simultaneously or an operator may switch or alternate between defense measures to subdue the attacker.

It is contemplated herein that valve 88 may include a protective cover or hinged cover to prevent involuntary operation of chemical dispensing system 80.

Referring again to FIG. 5, it is contemplated herein that if substrate W is dirty or dusty suction cup 29 may lose vacuum during use. To prevent portable light assembly 10 from falling a restraint cord such as strap 85 may be affixed on one end by an attachment mechanism such as threaded bolt 87 configured to affix such end to portable light assembly 10 and the other end of strap 85 may utilize a safety attachment mechanism such as magnet 89. Preferably, magnet 89 may be affixed to the trim, border, hood or roof top approximate substrate W to provide a backup attachment mechanism for portable light assembly 10. It is recognized that strap 85 may be configured as retractable ribbon held on a spring loaded spool in handle 16.

Referring now to FIG. 6, there is illustrated a cut away block diagram showing recording system such as audio/video/still recording system 90 that preferably includes a miniature digital camera and microphone such as digital camera 92, controller and memory 94, an on/off mechanism such as switch 44, power supply such as batteries 42, and input/output port such as communication port 96. Digital camera 92 is positioned in portable light assembly 10, preferably approximate housing bottom walls 14B1 and/or 14B2. Camera controller and memory 94 is positioned in portable light assembly 10, preferably approximate platform 60. Digital camera 92 and controller and memory 94 are electrically connected by wires 36 and are powered by batteries 42. When switch 44 is triggered or placed in the camera ON position it supplies power from batteries 42 to controller and memory 94 and digital camera 92, whereby controller and memory 94 controls the functionality of digital camera 92 to record audio and/or video data within view of portable light assembly 10. Moreover, an operator, such as an officer, may utilize audio/video recording system 90 of portable light assembly 10 to record or document via still frame, video, and/or audio recording of an encounter, well lit interior of a vehicle or building and the like. Moreover, the bright light source of portable light assembly 10 preferably enables portable light assembly 10 to record still frame, video, and/or audio data via audio/video recording system 90 through a well lit interior opposite substrate W. Communication port 96, such as USB port is preferably utilized to export or download data files such as still frame, video, and/or audio recordings from portable light assembly 10.

Moreover, communication port 96 may be configured as a transmitter and/or receiver to enable transmission of information and data from portable light assembly 10 and to enable receipt of external information, data, and operational instructions from an external transmitter. Such operational instructions may be utilized by controller and memory 94 to facilitate remote operation of portable light assembly 10. Still further, communication port 96 and/or controller and memory 94 of portable light assembly 10 may be outfitted with a transmitter that can broadcast a signal which can be tracked if, for example, a stopped vehicle drives away with portable light assembly 10 still attached.

In use, controller and memory 94 of portable light assembly 10 may be configured with a microprocessor and program that operates light emitting diodes 46 to effectively disorient a viewer such as a person who is resisting arrest or threatening the police officer. Moreover, controller and memory 94 may be configured to control voltage regulator and power amplifier 48 to create a bright strobe effect, multiple colors, wavering brightness, a positional and color pattern with light emitting diodes 46 that preferably is distracting, disorienting, and the like.

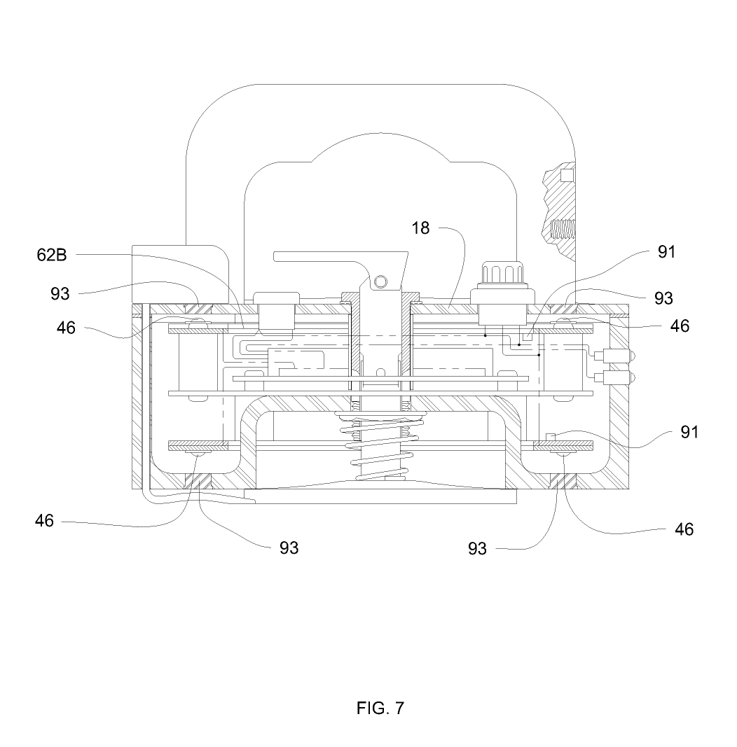

Referring now to FIG. 7 there is illustrated a side view of an example embodiment of portable light assembly 10. Portable light assembly 10 preferably includes a fourth planar platform, as part of platform 60, such as light source platform 62B configured to position an array of light emitting diodes 46 preferably in an annular ring, circular arc, or other configuration above battery platform 64 and adjacent top 18. Light emitting diodes 46 preferably emit light through transparent top 18 or aperture such as hole 93 therein and illuminate the space opposite non-transparent or substrate W.

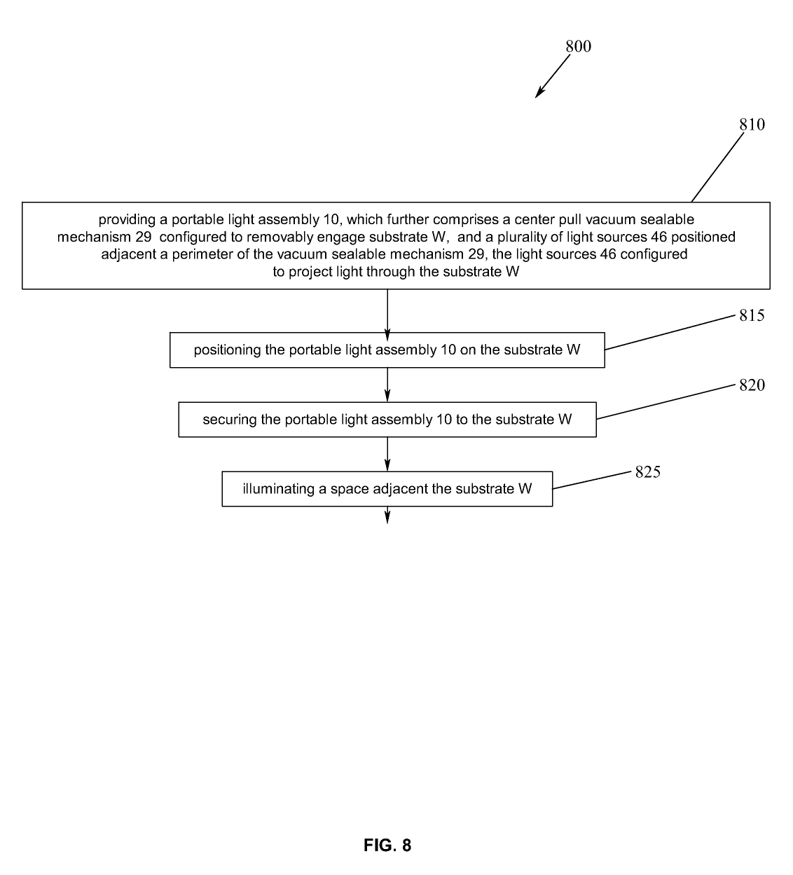

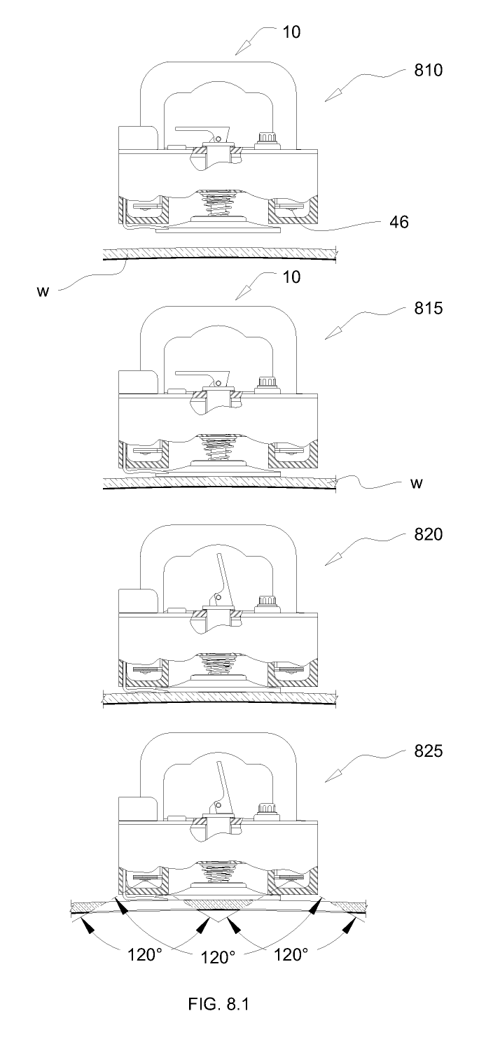

Referring now to FIG. 8, there is illustrated a flow diagram 800 of a method of affixing a portable light assembly to substrate W and illuminating the space adjacent substrate W. In block or step 810, providing portable light assembly 10, which further comprises a center pull vacuum sealable mechanism 29 configured to removably engage substrate W, and plurality of light sources 46 positioned adjacent perimeter such as edge 29.1 of the vacuum sealable mechanism 29, the light sources 46 configured to project light through substrate W or away from the substrate W as described above in FIGS. 1-7. In block or step 815, positioning portable light assembly 10 on substrate W. In block or step 820, securing portable light assembly 10 to substrate W. In block or step 825, illuminating a space adjacent substrate W or away from the substrate W.

Referring now to FIG. 8.1, there is illustrated portable light assembly 10, substrate W wherein portable light assembly 10 illuminates the space adjacent substrate W as described above in FIGS. 1-7. FIG. 810 provides portable light assembly 10 configured to removably engage substrate W, and a plurality of light sources 46 positioned adjacent vacuum sealable mechanism 29. FIG. 815 provides portable light assembly 10 positioned on substrate W. FIG. 820 provides portable light assembly 10 affixed to substrate W. FIG. 825, provides light sources 46 illuminating a space adjacent substrate W or away from the substrate W.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail, it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A portable light assembly for projecting light through a substrate, the assembly comprising:
a housing;
a center pull vacuum sealable mechanism integrated into said housing, said vacuum sealable mechanism configured to removably engage the substrate; and
a plurality of light sources positioned within said housing and adjacent a perimeter of said vacuum sealable mechanism, said light sources configured to project light through the substrate.

2. The portable light assembly of claim 1, further comprising a latch and a linkage mechanically coupled to said center pull vacuum sealable mechanism, said latch and said linkage configured to move a center portion of said vacuum sealable mechanism.

3. The portable light assembly of claim 1, further comprising a spring positioned between said housing and said center portion of said vacuum sealable mechanism, said spring configured to bias said vacuum sealable mechanism.

4. The portable light assembly of claim 2, further comprising a conduit centrally positioned within said housing, said conduit configured for said linkage to travel therein.

5. The portable light assembly of claim 1, wherein said vacuum sealable mechanism is circular shaped.

6. The portable light assembly of claim 1, wherein said housing further comprises a plurality of walls configured to maintain a sealed container therein.

7. The portable light assembly of claim 6, wherein said plurality of walls further comprises a bottom wall positioned adjacent said perimeter of said vacuum sealable mechanism, said bottom wall formed of a transparent material.

8. The portable light assembly of claim 1, further comprising a platform positioned within said plurality of walls, said platform configured to secure said plurality of light sources.

9. The portable light assembly of claim 8, wherein said platform configured to secure a power source, said power source in electrical communication with said plurality of light sources.

10. The portable light assembly of claim 9, further comprising a switch configured to be in electrical communication with said power source and said plurality of light sources.

11. The portable light assembly of claim 9, further comprising an indicator light configured to be in electrical communication with said power source, said indicator light configured to indicate a status of said portable light assembly.

12. The portable light assembly of claim 9, further comprising an input contact configured to be in electrical communication with said power source, said input contact protrudes through one of said plurality of walls.

13. The portable light assembly of claim 1, wherein said plurality of light sources further comprises light emitting diodes.

14. The portable light assembly of claim 6, wherein said plurality of walls further comprises a top wall opposite said bottom wall, said top wall configured as a removable lid.

15. The portable light assembly of claim 14, further comprising a handle positioned on said top wall, said handle configured to carry said portable light assembly.

16. The portable light assembly of claim 15, further comprising a threaded aperture formed in said handle, said threaded aperture configured to accept a threaded attachment.

17. The portable light assembly of claim 16, wherein said attachment configured to provide a backup attachment to said vacuum sealable mechanism.

18. The portable light assembly of claim 1, further comprising a vacuum release mechanism configured to disengage said vacuum sealable mechanism from the substrate, wherein said vacuum release mechanism is configured to operate through an internal conduit within said housing.

19. The portable light assembly of claim 12, further comprising a docking station configured to receive said portable light assembly.

20. The portable light assembly of claim 19, wherein said docking station further comprising an output contact configured to be in electrical communication with said input contacts.

21. The portable light assembly of claim 20, wherein said docking station further comprising an external power source configured to be in electrical communication with said output contacts.

22. The portable light assembly of claim 1, further comprising a pressurized chemical irritant dispensing system configured to dispense therefrom the pressurized chemical irritant held under pressure.

23. The portable light assembly of claim 7, further comprising a recording system configured to record activity through the substrate.

24. The portable light assembly of claim 23, wherein said recording system is positioned approximate said bottom.

25. The portable light assembly of claim 23, further comprising a communication port in electrical communication with said recording system, said communication port configured to export data from said recording system.

26. The portable light assembly of claim 1, further comprising a peripheral shield configured to block interfering light reflected from the substrate.

27. The portable light assembly of claim 1, wherein said housing further comprises a second plurality of light sources configured to project light away from the substrate.

28. The portable light assembly of claim 2, wherein said conduit functions to provide structural support to said housing.

29. A method of affixing a portable light assembly to a substrate comprising the steps of:
providing a portable light assembly, which further comprises a housing, a center pull vacuum sealable mechanism integrated into said housing, said vacuum sealable mechanism configured to removably engage the substrate, and a plurality of light sources positioned within said housing and adjacent a perimeter of said vacuum sealable mechanism, said light sources configured to project light through the substrate;
positioning said portable light assembly on the substrate;
securing said portable light assembly to the substrate; and
illuminating a space adjacent said substrate.
